(19) United States
(12) Patent Application Publication
(10) Pub. No.: US 2025/0093860 A1
(43) Pub. Date: Mar. 20, 2025

(54) Neural Network Supported Augmented Reality for Technician Support

(71) Applicant: Bell Textron Inc,, Fort Worth, TX (US)

(72) Inventors: Jeffrey W. Holcomb, Fort Worth, TX (US); Kristen Doelling, Grapevine, TX (US)

(21) Appl. No.: 18/470,662

(22) Filed: Sep. 20, 2023

(51) Int. Cl. G05B 19/418

(52) U.S. Cl. CPC G05B 19/41885; G05B 19/4183

(57) ABSTRACT

A system for technician support includes at least one processor, at least one stored artificial intelligence (AI) model stored therein, and a computer program for execution by the processor. The computer program includes instructions for determining an engineering process to be performed on a workpiece, and having one or more elements associated with an assembly process or a maintenance process for the workpiece, receiving sensor data from one or more sensors, the sensor data reflecting at least a physical state of the workpiece, providing the sensor data to the at least one AI model, causing the at least one AI model to process the sensor data to generate at least one classification result that indicates whether the sensor data indicates whether each element was correctly performed, and validating execution of the engineering process in response to each element being correctly performed, and providing a visual notification to a user.

### TECHNICAL FIELD

The present invention relates generally to systems and methods for using artificial intelligence (AI) to validate performance of engineering processes, and, in particular embodiments, to systems and methods for verifying, using AI models, that specified steps of an engineering process are properly performed, and providing augmented reality (AR) guidance on the engineering process during performance of the process.

### BACKGROUND

Modern avionics systems are extremely advanced and increasingly digital, requiring precision manufacturing with defect free production. The time required to learn how to maintain a modern rotorcraft is lengthy, the high technical skills required to maintain a modern rotor craft coupled with the high costs for downtime require high precision and high quality in assembly and maintenance of avionics systems. The precision and quality requirements coupled with increased automation require guarantees that all required manufacturing or maintenance steps are completed fully and accurately prior to customer inspection. Verification of parts, assembly steps and maintenance processes are required to ensure that final assemblies are correctly assembled or repaired, and so that the final assemblies can be certified as being correctly built or maintained.

### SUMMARY

An embodiment system includes at least one processor, and a non-transitory computer readable medium connected to the processor and having at least one artificial intelligence (AI) model stored therein, and further having a computer program for execution by the processor stored therein. The computer program includes instructions for determining an engineering process to be performed on a workpiece, where the engineering process has one or more engineering process elements associated with one of an assembly process or a maintenance process for the workpiece, receiving sensor data from one or more sensors associated with the workpiece, the sensor data reflecting at least a physical state of the workpiece, providing the sensor data to the at least one AI model, causing the at least one AI model to process the sensor data to generate at least one classification result, where the at least one classification result indicates whether the sensor data indicates whether each engineering process element of the one or more engineering process elements was correctly performed, validating execution of the engineering process in response to each engineering process element of the one or more engineering process elements being correctly performed, and providing a visual notification to a user that the execution of the engineering process has been validated.

An embodiment method includes determining, by a monitoring system, an engineering process to be performed on a workpiece, where the engineering process has one or more engineering process elements associated with one of an assembly process or a maintenance process for the workpiece, where the monitoring system includes at least one artificial intelligence (AI) model, receiving sensor data from one or more sensors associated with the workpiece, the sensor data reflecting at least a physical state of the workpiece, providing the sensor data to the at least one AI model, causing the at least one AI model to process the sensor data to generate at least one classification result, where the at least one classification result indicates whether the sensor data indicates whether each engineering process element of the one or more engineering process elements was correctly performed, validating execution of the engineering process in response to each engineering process element of the one or more engineering process elements being correctly performed, and providing a visual notification to a user that the execution of the engineering process has been validated.

An embodiment system includes at least one processing circuit, configured to implement at least one artificial intelligence (AI) model, and further configured for receiving sensor data from one or more sensors associated with a workpiece, the sensor data reflecting at least a physical state of the workpiece, providing the sensor data to the at least one AI model, causing the at least one AI model to generate, according to the sensor data, classification results for a plurality of engineering process elements for an engineering process that is associated with one of an assembly process or a maintenance process for the workpiece, where each classification result of the classification results is associated whether each engineering process element of the plurality of engineering process elements was correctly performed, validating execution of the engineering process in response to each engineering process element of the plurality of engineering process elements being correctly performed, providing a visual notification to a user that the execution of the engineering process has been validated in response to the execution of the engineering process being validated, and providing a visual notification to the user that the engineering process was incorrectly completed in response to the execution of the engineering process not being validated.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1A-1B are symbolic diagrams illustrating architectures and training systems for AI models according to some embodiments;

FIG. 2 is a system diagram illustrating a system for training an AI model according to some embodiments;

FIG. 3 is a flow diagram illustrating a process for training an AI model to recognize to-be performed engineering processes with engineering process elements according to some embodiments;

FIG. 4 is a conceptual diagram for an arrangement using an AI model to recognize to-be performed engineering processes according to some embodiments;

FIG. 5 is a flow diagram illustrating a method for validating execution of a to-be performed engineering process using an AI model according to some embodiments;

FIGS. 6A-6D are perspective diagrams illustrating an engineering process that may be monitored by an AI model according to some embodiments; and

FIG. 7 is a diagram illustrating a system for providing engineering process information according to some embodiments.

### DETAILED DESCRIPTION OF ILLUSTRATIVE EMBODIMENTS

The complexity of modern avionics systems requires high precision and high quality in design, assembly, operation and maintenance. Embodiments of the presented principles provide for efficient use of expensive technician labor, and allow for verification that systems are assembled correctly, tracking of parts, and tracking of the execution of engineering processes for provision of assembly assistance to technicians. The systems and methods described below utilize a combination of AI and neural network architectures to recognize avionics components, track technician's interactions with the components, verify the accuracy of system assembly and maintenance, and provide interactive models and windows to aid technicians in handling avionics components. The AI and neural network architectures may include object detection architectures, neural radiance field architectures, depth estimation architectures, gesture or motion tracking architectures, and the like.

The AI architectures increase accuracy of manufacturing process execution, increase traceability, increase worker satisfaction, and increase remote interactivity with the customer through tele-immersion technologies capable of bringing the customer into the product inspection and validation process via remote augmented reality technology. Additionally, the systems and methods described below provide increased customer engagement through safe and non-interventive inspection of finished products. The AR system permits robust and automated maintenance schedule tracking by verifying that specified steps of maintenance processes are performed correctly. The AR system also permits the overall maintenance procedure to be tracked and maintenance scheduled based on the verification of earlier maintenance.

Thus, the described systems and methods improve worker and technician effectiveness using augmented reality and AI or neural network technology for improved guidance during assembly or maintenance processes. Augmented reality, virtual reality, AI, neural networks, and tele-immersion technologies increase customer engagement with the manufacturing and maintenance processes resulting in defect reduction, increased efficiency, and engineering process visibility. AR systems with AI and neural network assistance can be used to identify parts, determine process steps, and recommend parts, process steps and other assembly or maintenance-related actions. Using AR systems with AI or neural network systems as disclosed herein reduces technician training costs using parts recognition and recommendation for technicians. While the engineering process itself may be completed and fully validated or verified as being accurate, the AR system, with the associated AI systems, assists the technician in following the engineering processes, and expedites the validation or documentation that the technician did employ, perform, or execute, the engineering process properly. Thus, validation of an engineering process comprises validating execution or performance of the engineering process, which may include verifying that an engineering process has been performed correctly, that each element of an engineering process was performed correctly, that no steps or elements of an engineering process was omitted, or that no additional steps or detrimental actions were taken during performance of the engineering process. This improves production accuracy, on-site maintenance, and repair technician effectiveness by providing improved engineering process guidance using augmented reality and neural network technology. Additionally, the use of AR systems permits remote technician support by taking advantage of the sensor systems on an AR headset.

In some embodiments, an AI system may use data from cameras, sensors, and the like, to recognize parts, assembly or maintenance processes, and the like, and correlate performed assembly or maintenance elements against a defined assembly or maintenance processes to verify that each assembly or maintenance step in an engineering process is correctly performed. This provides the ability to use third party verification of the correct performance of the engineering process. Additionally, the sensor data, such as camera data, may be used for other functions, such as providing video to customers or third parties, or to remote technicians. The use of AI permits automated recognition and tracking of parts through the lifetime of machinery so that the use and inventory of individual parts may be tracked, and scheduling of future maintenance.

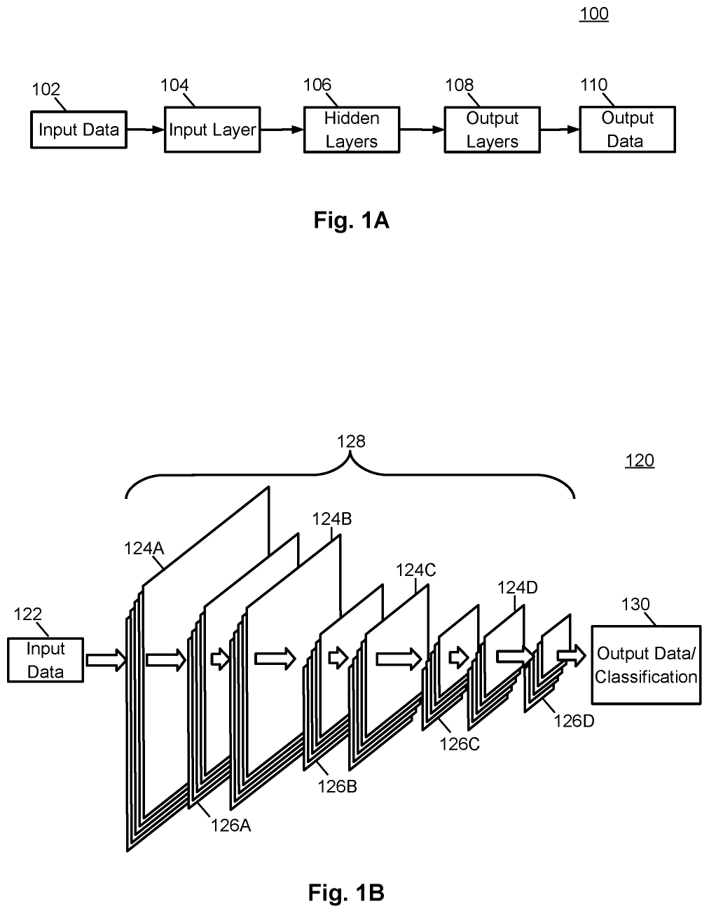

FIGS. 1A-1B are symbolic diagrams illustrating architectures and training systems for AI models according to some embodiments. AI models are a set of mathematical functions that can be used to correlate incoming data with known elements, such as images, sounds, motions, and the like. Thus, an AI model may be a set of functions used for image, sound, text or motion recognition. A commonly used AI recognition model is a convolutional neural network (CNN).

FIG. 1A is a symbolic diagram illustrating layers of an AI model 100 according to some embodiments. An AI model 100 takes in input data 102 though an input layer 104. The input layer 104 converts input data 102 into a format usable by hidden layers 106. For example, in an image recognition or computer vision AI model, the input data 102 may be, for example, an image with two dimensions. In some embodiments, the input layer 104 may convert the image input data 102 into a numeric representation such as a matrix with the data values reflected in the matrix. In other embodiments, the input layer 104 may convert multidimensional input data 102 into a single dimension array, apply filters, trim or normalize input data 102, or perform other pre-processing functions.

The input layer 104 provides the prepared data to a set of hidden layers 106. In a CNN, the hidden layers 106 provide one or more convolutions or filters. The hidden layers 106 may use filters that are trained by applying weights and biases to a variety of filters to identify desired features from the image data. In some embodiments, the hidden layers 106 may provide probabilities or other data related to extracted or identified features. A CNN may take advantage of hierarchical patterns in input data and assemble patterns of increasing complexity using smaller and simpler patterns in the filters of convolutional layers. Thus, CNNs utilize the hierarchical structure of the data they are processing. CNNs break input data down into smaller, simpler features, which are represented by the filters of the convolutional layers. These filters are applied to different regions of the input to extract the relevant information. As the network progresses through the layers, these features are combined and assembled into more complex patterns, allowing the network to learn increasingly abstract representations of the input.

An output layer 108 may be used to classify data received from the hidden layers 106. The output layer 108 uses the output from the hidden layers 106 to determine a probability that a particular image belongs to a particular classification.

FIG. 1B is a symbolic diagram illustrating layers of an CNN AI model 120 according to some embodiments. A CNN AI model 120 may have hidden layers 128 that receive input data 122 and that perform mathematical processes on the input data 122 so that the input data 122 may be classified. The hidden layers may include one or more convolutional layers 124A-124D, and one or more pooling layers 126A-126D. In some embodiments, each convolutional layer 124A-124D comprises one or more trainable filters or kernels that are applied to the data. Each convolutional layer 124A-124D convolves the input by a filter and passes the result to a next layer. The convolutional layers 124A-124D abstract image data to a feature map, or an activation map.

Pooling layers 126A-126D may be used after convolutional layers 124A-124D to reduce the dimensions of a feature map or other data by combining the outputs of neuron clusters at a layer into a single layer of a following layer. Thus, a pooling layer 126A-126D may combine small clusters of information to reduce the size of data before providing the reduced feature map to a next convolution layer 124A-124D. In some embodiments, pooling may be max pooling, where the maximum value in a local cluster may be provided as a neuron value to the next convolutional layer. In other embodiments, pooling may use average pooling by averaging the values of data in a particular cluster, and passing the average value as a neuron value to a next convolutional layer. The output from the hidden layers 128 may then be passed for classification to a classification element 130 such as an output layer, or the like.

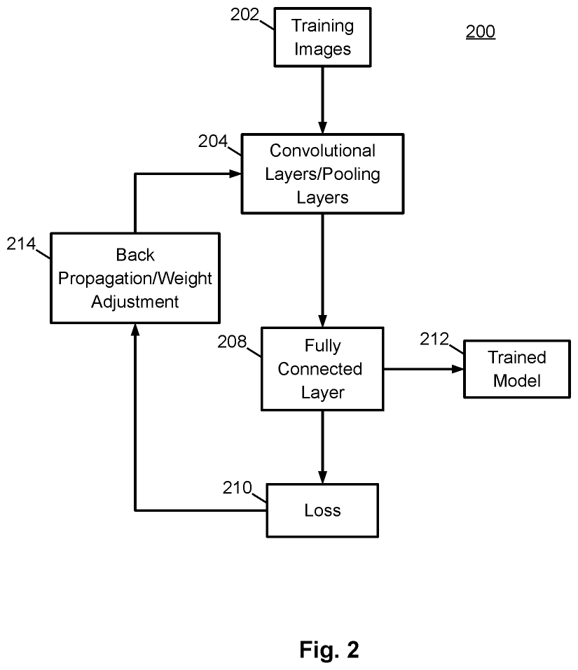

FIG. 2 is a system diagram illustrating a system 200 for training an AI model according to some embodiments. An AI model uses a set of weights and biases used to make predictions and the error for those predictions is calculated. For image recognition systems, the predictions may be predictions of whether an image is part of an identified class. A training data set having one or more training images 202 is identified. The training data set provides data that can be used to train an AI model to identify, or avoid, certain types of data, and relate that data to specified categories of classifications. For example, when training an image recognition AI model, the training images 202 may be static images, videos, or the like, and may have data that can be positively identified as belonging to a desired classification, and data that may be positively identified as not belonging to a desired classification. The desired classification may be a category of conceptual items that the AI model should identify an analyzed image as belonging to, or not belonging to. For example, where the desired classification is a dog, the training images may be of dogs and other items, and the AI model may be trained to identify dog images from the training data set as belonging to the dog classification, and to identify non-dog images from the training data set as not belonging to the dog classification. In embodiments of an engineering process identification AI model, the training images 202 may include positive classification data such as video, images, or other data related to tools, parts, installation or maintenance actions, and the like, and the AI model may be trained to associate the positive classification data with an engineering process, and one or elements of an engineering process. Additionally, the training images 202, or the training data, may also have negative classification data that may include video, images or other data that are not associated with the identified engineering process, and in some embodiments, may also include video or images illustrating incorrect features such as process steps, elements, tools, actions, or the like. This permits the AI model to be trained on what is part of an identified engineering process, what is not part of the engineering process, and what is an incorrect element for the engineering process. For example, an engineering process for vehicle transmission installation may include placing an access panel, inserting bolts in a desired location, and torqueing the bolts to a specified torque in a specified pattern. Training images for training an AI model to recognize such an engineering process may include positive classification data such as video of a technician placing the access panel in a correct location, and the video may be positively associated with the overall installation process, and with subprocesses or process elements such as access panel installation. The AI may have filters that identify the correct part, the correct location, the correct orientation of the panel, the correct alignment of the panel, or other relevant parameters. The AI may be trained to positively recognize correct training images as belonging to the identified classification. The training images may also include negative classification data such as images, video, or other data that show non-related videos, or incorrect process steps, such as placing the access panel in an incorrect location, in an incorrect orientation, or bolts being torques with an incorrect tool or to an incorrect torque.

The training images 202 may be preprocessed by an input layer (not shown) to prepare the training images 202 for filtering through one or more hidden layers such as convolution layers and pooling layers 204. The convolution layers 204 may have filters with adjustable weights or biases that affect the weight given to the respective filter when processing data. The training images 202 may be processed through the convolution layers and pooling layers 204, and the resulting data is output to one or more fully connected layers 208.

The fully connected layers 208 provide classification for each image from the training images. In some embodiments, the fully connected layers 208 generate probabilities that each image belongs to a particular classification. In some embodiments, a Softmax function is applied to data output from the convolutional layers and pooling layers 204. Softmax is an activation function that scales numbers or unnormalized final scores (logits) into probabilities. In some embodiments, a threshold may be applied to the probabilities or other output generated by the fully connected layers 208 to determine whether the image affirmatively meets the classification criteria. For example, the system may use a 90% threshold for classification, and a training image 202 that has a greater than 90% chance of belonging to a particular class is affirmatively classified as being in the class. Alternatively, a training image that has an 20% chance of belonging to a particular class may be classified as being outside the class. In some embodiments, the system may use a lower threshold when classifying training images 202 as being outside the class, with probabilities falling between the threshold resulting in the training image being undefined or unknown with respect to the class. Therefore, the system may have a lower threshold of 10%, and a training image 202 identified as having a 10% chance of being in the class may be identified as affirmatively being outside of the class, while a 25% chance of the training image 202 being in the class may result in an undefined or unknown classification for the training image 202.

In some embodiments, fully connected layers are feed forward neural networks. The fully connected layers 208 are densely connected, meaning that every neuron in the output is connected to every input neuron. In a fully connected layer 208, every output neuron is connected to every input neuron through a different weight. This is contrast to a convolution layer where the neurons are not densely connected but are connected only to neighboring neurons within a width of a convolutional kernel or filter. However, in a convolutional layer, the weights are shared among different neurons, which enables convolutional layers to be used with a large number of neurons.

The input to the fully connected layers 208 is the output from the final convolutional layer or final pooling layer 204, which is flattened and then fed into the fully connected layer 208. During training of an AI model, outputs from the fully connected layer 208 are passed to a loss element 210 that evaluates the results of the AI model processing and provides data used to adjust weights and biases of the convolutional layers by back propagation or weight adjustment 214.

The loss element 210 specifies how training penalizes the deviation between the predicted output of the network, and the true or correct data classification. Various loss functions can be used, depending on the specific task. In some embodiments, the loss element 210 applies a loss function that estimates the error of a set of weights in convolution layers of a neural network. For example, errors in an output may be measured using cross-entropy. For example, in some training systems, the likelihood of any particular image belonging to a particular class is 1 or 0, as the class of the images is known. Cross entropy is the difference between an AI model predicted probability distribution given the dataset and the distribution of probabilities in the training dataset. The loss element 210 may use a cross entropy analysis to determine loss for a training image 202 or set of training images 202.

Back propagation allows application of the total loss determined by the loss element 210 back into the neural network to indicate how much of the loss every node is responsible for, and subsequently updating the weights in a way that minimizes the loss by giving the nodes with higher error rates lower weights, and vice versa. For example, in some embodiments, a loss gradient may be calculated, and used, via back propagation 214, for adjustment of the weights and biases in the convolution layers. A gradient descent algorithm may be used to change the weights so that the next evaluation of a training image 202 reduces the error identified by the loss element 210, so that the optimization algorithm is navigating down the gradient (or slope) of error. Once the training images 202 are exhausted, or the loss of the model falls below a particular threshold, the AI model may be saved, and used as a trained model 212.

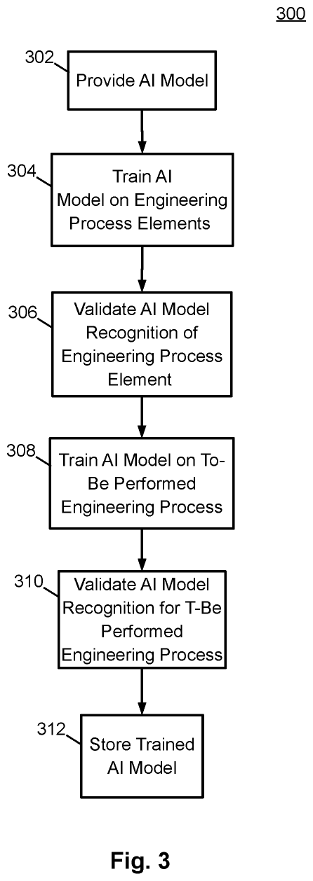

FIG. 3 is a flow diagram illustrating a process 300 for training an AI model to recognize to-be performed engineering processes with engineering process elements according to some embodiments. A to-be performed engineering process is any process for working with a physical object, and some embodiments, may include assembly, manipulation, inspection, or other activity related to physical parts. Once the to-be performed engineering process is actually being performed, or after it is performed, it may be referred to as a performed engineering process. In some embodiments, the physical element may be a computing or electrical system, and the engineering process may include installation, management, adjustment, or use of software, manipulation of electrical systems by, for example, setting parameters of an electrical system, or the like. Any element having multiple requirements or steps may be considered to be an engineering process, and any element that is part of a larger process may be an engineering process element. In some embodiments, a to-be performed engineering process may have one or more engineering process elements, which may be steps, requirements, parameters or other elements associated with the overall engineering process. For example, a to-be performed engineering process may be assembly of a transmission, and the engineering process elements may be steps and requirements for applying parts to assemble the transmission. The engineering process elements may be specific individual steps, requirements, parameters, pieces, or the like required for the transmission, or may be more general elements that have their own engineering process elements as sub-elements.

In some embodiments, the to-be performed engineering process and engineering process elements are identified from engineering process data stored in a monitoring system, a database, or the like. The engineering process data may be developed by AI models by observing correct performances of performed engineering processes, by data such as assembly or repair instructions from manufacturers or repair facilities, or the like.

In the example of assembly of a transmission, the overall assembly of the transmission may be the to-be performed engineering process, and may have associated engineering process elements such as provision of a transmission casing, placement of an output shaft, installation of output bearings, installation of a gear assembly, installation of seals, and the like. In this example, the installation of output bearings may itself be a to-be performed engineering process having engineering process elements that, for example, include lubricating the bearing, placing the lubricated bearing in a particular location in the transmission casing, and bolting a bearing retainer to the transmission casing. The engineering process elements may have associated actions, parameters, objects, tools or other requirements. For example, the engineering process element of bolting a bearing retainer to the transmission casing may require placement of multiple bolts in desired locations so that each bolt extends through the bearing retainer, and torqueing each bolt to a specified torque in a specified pattern using a specified tool such as a calibrated torque wrench. Thus, the engineering process element of bolting the bearing retainer to the transmission casing requires parts, such as bolts, the bearing, and the bearing retainer, requires specific actions, such as torqueing bolts on a specific pattern, requires specified parameters, such as the specified torque of the bolts or the location of bolt placement, and requires specified tools, such as using a particular calibrated torque wrench.

In block 302, an AI model is provided. In some embodiments, an already trained AI model may be used, and may be further trained to specifically recognize to-be performed engineering processes and engineering process elements. In other embodiments, an untrained AI model may be used. The AI model may be a computer program, software or data stored on a non-transitory computer readable medium, and may be run or processed on a processor. In some embodiments, a system may have one or more AI models, for example, AI models that are used to recognize different features, such as gesture recognition models, object recognition models, depth estimation models, vision transformer (ViT) models, objection detection models such as a you only look once (YOLO) model or RetinaNet model, segmentation models, or the like.

In block 304, an AI model is trained on engineering process elements. In some embodiments, the AI model is provided with training related to identified engineering process elements, and the AI model is run to teach the AI model to recognize features of the engineering process element. The system may train AI models to categorize training data as belonging to particular engineering process elements so that, when trained, the AI model is able to determine whether an input can be classified as reflecting a correct engineering process element. In some embodiments, the training data may be video from previous engineering processes elements, for example, using quality assurance, surveillance, or other video data from previous execution of the assembly process. Thus, an AI model may be trained to recognize transmission assembly engineering process elements from, for example, video of transmission assemblies that occur prior to the AI being trained. The training data may also include negative classification data, such as video or images, that illustrates different engineering processes, incorrect execution of one or more engineering process elements, or the like, so that the AI model learns to differentiate between correct and incorrect elements, parts, parameters, tools, or the like, that are required for a particular engineering process element. In some embodiments, engineering process elements may be identified for a target or to-be performed engineering process, and one or more AI models may be trained on the engineering process elements so that at least one AI model is trained to identify each element that is identified as being an AI verifiable part of a to-be performed engineering process.

In block 306, validation of the AI model recognition of an engineering process element execution is performed. In some embodiments, the AI model may require certification or other assurance of the accuracy of the AI model's ability to correctly identify required elements of the engineering process element. For example, validation data that is different from the training data may be run though the AI model, and then results of the AI model engineering process element recognition are compared to the expected output values for the validation data. Using a validation data set that is different from a training dataset avoids false validation results by ensuring that an AI model does not simply give a known result for an image that the AI model has previous processed during initial training.

In some embodiments, validating the engineering process elements may include verifying that the AI model, after training, is able to accurately recognize engineering process elements according to a threshold. For example, using a 90% threshold, an AI model trained to recognize 10 engineering process elements may be validated against all 10 engineering process elements by verifying that the AI model correctly recognizes 90% or more of all validation data for each of the 10 engineering process elements. Thus, the AI model may be separately validated for each engineering process element. In some embodiments, if the AI model is unable to be validated for each engineering process element, the system may raise an exception, perform more training on the AI model, or take other steps to address the deficiencies in the AI model.

In block 308, one or more AI models are trained on a to-be performed engineering process. Training on a to-be performed engineering process may include tying together one or more engineering process elements under a to-be performed engineering process. For example, the AI model may be trained to recognize a proper order in which the engineering process elements should be performed, identify any engineering process elements that were skipped or are missing from a to-be performed engineering process, identify any elements that have been added, or additional steps that are taken within, or between, engineering process elements, or the like.

In block 310, validation of the AI model recognition of a to-be performed engineering process recognition is performed. In some embodiments, the combination of engineering process elements is validated against validation data having multiple engineering process elements. Validation data for the overall to-be performed engineering process may be run though the AI model, and then results of the AI model recognition of the to-be performed engineering process are compared to the expected output values for the validation data. Validating the recognition of the to-be performed engineering process performance may include validating one or more engineering process elements as well as the combination of a plurality of engineering process elements. For example, for a transmission assembly process, validation of engineering process elements may include validation that the AI model properly recognizes placement of a lubrication of bearing, placement of the bearing, and placement of a bearing retainer, and proper installation of bolts for the bearing retainer. In the same example, the validation of the engineering process may include validating that the AI model recognizes that the steps are performed in a desired order, and that no engineering process elements are left out or added, for example, that, after a bolt is properly installed, there was no action taken to loosen or otherwise affect the proper installation of the bolt.

In some embodiments, validating the recognition of the to-be performed engineering process may include verifying that the AI model, after training, is able to accurately recognize the to-be performed engineering process according to a threshold. For example, using the 90% threshold, an AI model trained to recognize a to-be performed engineering process may be validated against each to-be performed engineering process by verifying that the AI model correctly recognizes 90% or more of all validation data for the to-be performed engineering process.

In block 312, the trained model is stored. Once the AI model is trained, and the recognition of each target or to-be performed engineering process and engineering process element is validated, the AI model may be ready to use, and may be stored or otherwise maintained so that the weights and biases that were used to reach proper validation are maintained.

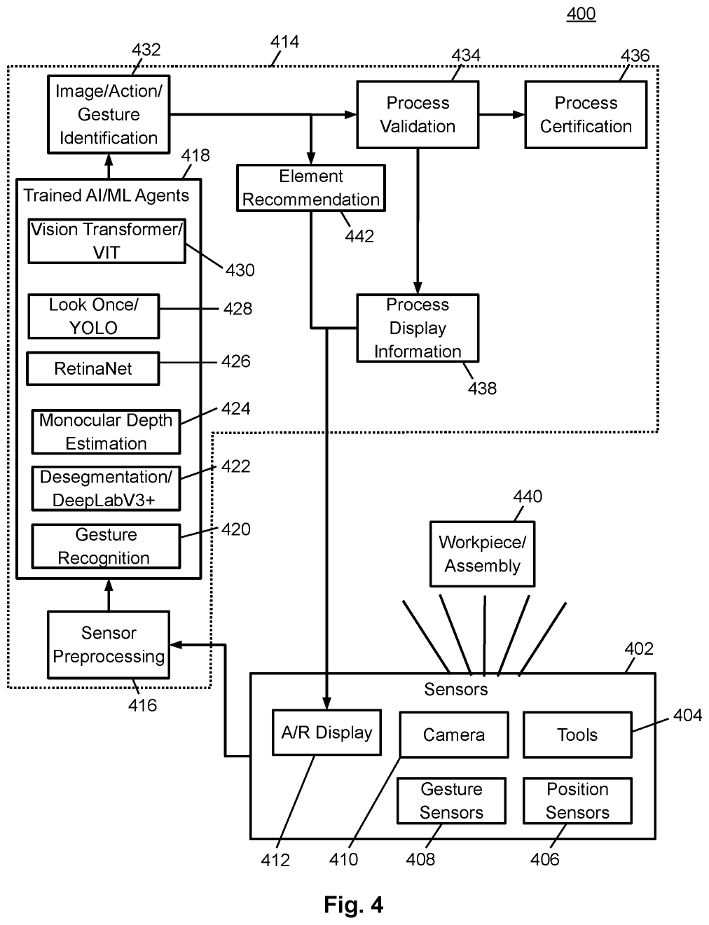

FIG. 4 is a conceptual diagram for an arrangement 400 using an AI model 418 to recognize engineering processes according to some embodiments. The arrangement 400 may be a monitoring system 414 that uses data from sensors 402 associated with a workpiece 440 or assembly.

In some embodiment, the monitoring system 414 is a system with a processing circuit such as one or more processors and that stores computer programs, instructions and data on a non-transitory computer readable medium. The instructions include instruction to monitor engineering processes and engineering process elements using AI models, and to validate and certify performance of engineering processes and engineering process elements. In other embodiments, one or more elements of the monitoring system may be in processing circuits such as application specific integrated circuits (ASICs), field programmable gate arrays (FPGAs), dedicated discrete circuits, or the like. For example, a neural network may be disposed in an FPGA, with sensor input received at the FPGA for processing by the neural network on the FPGA. The output may be connected to a verification output such as a verification light, or the like, to indicate that execution of an engineering process has failed or not yet been performed correctly.

In some embodiments, one or more sensors 402 generate data reflecting a physical state of a workpiece and an environment around a workpiece. The one or more sensors 402 may be deployed to observe, or be used with, a workpiece 440 on which an engineering process is being performed. The sensors 402 may include sensor elements such as cameras 410, gestures sensors 408, position sensors 406, tools 404 and AR displays 412. In some embodiments, the cameras 410 may read a visual field and may generate image data such as still images or video of the workpiece 440, technicians, tools 404, and performance of engineering processes and the like. In some embodiments, the gesture sensors 408 may use lidar, radar such as millimeter wave radar, sonic, or other types of gesture sensors that generate gesture data. In some embodiments, the position sensors 406 may be reflective position sensors, such as radar, sonar, lidar or the like, or may be visual position sensors such as visible light cameras, or may be GPS or radio ranging or position sensing system, or may be another type of position sensing system. The position sensors 406 generate position data for parts, technicians, tools, and the like, during the engineering process. In some embodiments, tools 404 may also be used to generate parameter data that is reported to the monitoring system 414. For example, smart tools, such as electronic torque wrenches, may report a torque being applied by the torque wrench when used. In another example, a smart power driver may be used to drive a bolt, nut, screw or the like, and may report that the device was used at a certain time or certain location. An AR display may include one or more sensors, such as a camera, gesture sensor, or the like, and may use that data for display to the user, but may also send the data to the monitoring system 414. The sensors 402 send data to the monitoring system 414, which may store the data for later validation, model recognition confirmation, audit, and the like. Additionally, the monitoring system 414 may use the sensor data for the engineering process recognition. In some embodiments, the monitoring system has a sensor preprocessing element 416 that prepares the sensor data for use by one or more trained AI or machine learning (ML) agents 418. The AI agents 418 may include one or more different types of agents. In some embodiments, the AI agents 418 may include gesture recognition models 420, depth estimation models 424, ViT models 430, object detection or recognition models such as YOLO models 428 or RetinaNet models 426, segmentation models 422 such as DeepLabV3+ models, or the like. The AI agents 418 may be provided with data related to a target engineering process, and may attempt to classify data received from the sensors as indicating proper implementation of the target engineering process.

In some embodiments, multiple AI agents perform classification on data from the sensors after processing, and may provide outputs that are correlated or used together for data classification in an image, action and gesture identification element 432. An engineering process observed by the sensors 402 may then be validated by a process validation element 434. In some embodiments, validating the engineering process may include saving classification related data from the AI agents or image, action and gesture identification element 432 related to classification or verification of engineering process elements, the overall engineering process, or other related data.

The classification related data may be used to verify that each element of an engineering process has been performed correctly. Elements identified for an engineering process may be individually validated, for example, as an engineering process is performed. This permits generation of display data by a process display information element 438 for transmission to, and display by, the AR display 412 so that a technician using the AR display 412 may be visually guided though the engineering process step-by-step. Additionally, in some embodiments, an element recommendation element 442 may also use the classification data to determine next steps or engineering elements that are likely needed in an engineering process, to recognize parts or features on a workpiece that are incorrect, broken, worn, or otherwise need to be replaced. The element recommendation element 442 may generate recommendation data for display to a technician though the AR display 412.

In some embodiments, once an engineering process is complete, a process certification element 436 may certify or otherwise authenticate that the workpiece 440 was assembled, repaired, inspected or worked on according to a specified engineering process, and that each step of the engineering process, or each engineering process element, was completed correctly. Thus, documentation of task completion or other validation information may be sent to a storage system such as management system, a central repository, or like, including, but not limited to, a database, a certifying authority or certification storage, inventory system, virtual model tracking system, part or maintenance manage system, or other tracking system. The documentation or validation information may be used for verification that an engineering process was performed correctly, or for tracking of maintenance, parts, health history, or the like.

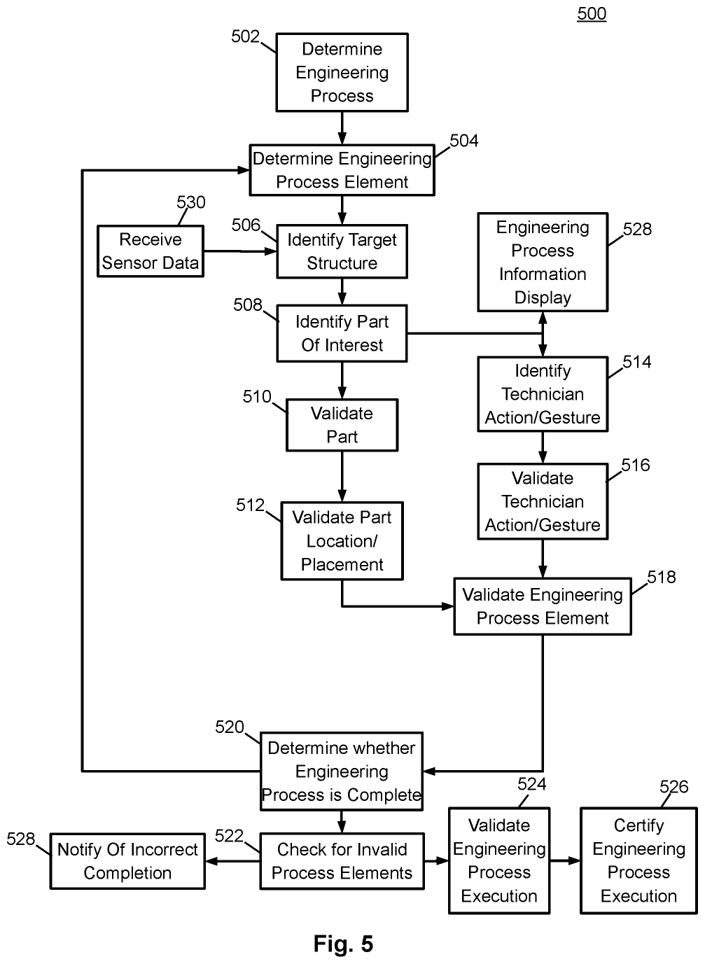

FIG. 5 is a flow diagram illustrating a method 500 for validating execution of an engineering process using an AI model according to some embodiments. In block 502, an engineering process is determined. In some embodiments, the determination of an engineering process may be due to a user or other process indicating that a specific engineering process will be performed, such as during assembly of a workpiece. For example, during a transmission maintenance engineering process, after an engineering process for removing a casing is performed, the monitoring system may determine that a gear train may be a next engineering process to be performed, and may identify the gear train removal engineering process as the determined or identified engineering process. In another example, a technician beginning a transmission maintenance process may identify the transmission maintenance process as the identified or determined engineering process. In other embodiments, the monitoring system may automatically identify a part or assembly, may identify a state or condition of a part or assembly, and determine which engineering process needs to be performed. For example, a monitoring system may monitor a technician as they disassemble a transmission, and may identify gears or clutches as being worn and being in need of replacement, and may determine that a relevant replacement process is a target or determined engineering process.

In block 504, an engineering process element is determined. In some embodiments, the engineering process element may be determined according to an order of engineering process elements for the relevant engineering process. For example, the engineering process may be determined by identifying the next engineering process element in a list.

In block 530, the monitoring system may receive sensor data related to a workpiece, technician, tool or other relevant aspect or engineering process performance. For example, the monitoring system may receive video data from cameras in a workspace. The video data may have data showing actions, gestures, and tools a technician uses to manipulate or work on a work piece.

In block 506, a target structure may be identified. The target structure may be a workpiece or other structure on which an engineering process or engineering process element is being, or will be, performed. In block 508, a part of interest may be identified. In some embodiments, the part of interest may be a part being removed from, or added to the target structure. In other embodiments, the part of interest may be a part of the target structure that is being addressed while performing the engineering process element. In some embodiments, an AI model may perform image or object recognition on the received sensor data, and may categorize the recognized objects as parts and structures associated with the engineering process element to determine that a recognized object is the part of interest or target structure.

In block 510, the monitoring system may validate the part. In some embodiments, the monitoring system may determine whether the part identified as the part of interest is the correct part, and may identify a serial number, or other unique identifying information for the part, which may be recorded for the target structure and associated with the engineering process and engineering process element so that the maintenance schedules, part lifetime, or other relevant device management information may be tracked and verified. In other embodiments where, for example, unique identifying information is not available for the part of interest, the monitoring system may validate the part by verifying that a part is the correct size, quality, type, or has other parameters required by the engineering process. For example, where a bolt is being installed, the monitoring system may verify that the bolt is a correct size, a correct grade, or has other parameters. The monitoring system may validate the part after the monitoring system positively classifies the part of interest as a part permitted or required by the engineering process element.

In block 512, the monitoring system may validate the location or placement of the part of interest. In some embodiments, an AI model analyzing the received sensor data may determine the location or placement of the part of interest, and verify that the placement or location is permissible or required for the engineering process. The AI model validating the part location or placement may be the same AI model that validates the part, identifies the part of interest, or identifies the target structure, or may be a separate AI model. For example, an object recognition AI model may be used to identify the target structure and validate the part, and a position sensing AI model may be used to determine and validate the part location or placement.

In block 514, a technician action or gesture may be identified by the monitoring system. In some embodiments, an AI model, such as a gesture sensing AI model, object recognition AI model, or a combination of AI model types may attempt to identify elements of a technician's action or gesture such motions performed by the technician, to identify tools used by a technician, or parameters resulting from the technician's actions, and to classify the elements of the technician's action or gesture as a parameter or requirement of an engineering process element. For example, a gesture sensing AI model may determine that a technician installs a bolt by using a wrenching action, and an object recognition AI model may determine that the technician is using a specific torque wrench, and may recognize that the technician has used the torque wrench to torque the bolt to a particular torque.

In block 516, the monitoring system validates the technician's actions or gestures. In some embodiments, the monitoring system determines that each requirement for action or a gesture by a technician required by an engineering process is performed correctly. In some embodiments, validating the gesture may include validating that the technician gesture or movement is ergonomically correct or conforms to an approved body placement or movement.

In block 518, execution of the overall engineering process element is validated by the monitoring system. In some embodiments, the monitoring system determines whether all requirements for an engineering process element are met. For example, each AI model may attempt to classify parts, part locations, part usage, technician actions or gestures, and the like, and may generate a classification result. The monitoring system may determine that the part and location of a part were validated, and that the technician action or gesture, and elements of the technician's action or gesture were validated, which may be based on the validation results. The monitoring system may determine that all requirements for the engineering process element have been performed and validated so that no requirements for the engineering process are missed. Once the execution of the engineering process is validated, the monitoring system may record data related to the engineering process element for verification and auditing purposes, for later display, for report generation, or the like. For example, video received by the monitoring system showing the performance of the engineering process element may be stored so that the video may be reviewed or shown to illustrate performance of the engineering process element, to run analysis of the engineering process element by another AI model, or the like.

In block 528, engineering process data may be displayed to a user. In some embodiments, data related to the engineering process or engineering process elements may be displayed in an AR display, tablet, or the like, used by a technician, or may be displayed to a third party, such as supervisor, customer, remote assistance party, or the like, so that the third party may observe the engineering process performance supplemented with data from the monitoring system. For example, once the monitoring system determines the engineering process and process element, a list of process elements, parameters, steps, tools, or the like, required for the engineering process may displayed to the technician to guide the technician though the relevant engineering process or engineering process element. Additionally, in some embodiments, the monitoring system may display a notice to the technician, or to another monitoring party, if a portion of the process element is not complete, or is not completed correctly, so that the technician may properly complete the engineering process element.

In block 520, the monitoring system determines whether the engineering process is complete. In some embodiments, if each engineering process element has not been performed, or if the most recently competed engineering process element is not the last engineering process element for the engineering process, the method may repeat the element processing blocks by returning to block 504 to determine a next engineering process element for the engineering process.

In block 522, the monitoring system checks for invalid process elements. In some embodiments, the monitoring system may also determine whether any particular engineering process element was not validated, and may, in block 528, notify the technician of incorrect completion of a particular engineering process element, using, for example, a visual notification, or return to block 504 to have the technician address any deficiencies in the performance of the engineering process element.

After the monitoring system determines that the engineering process is complete and that there are no invalid engineering process elements, the monitoring system, in block 524, may validate the engineering process execution. The monitoring system may record data related to the successful completion or execution of the engineering process, and may, in some embodiments, provide a visual notification to notify the technician or a monitoring third party of validation of the engineering process execution. In some embodiments, an alert, notification, display, message or other indication may be provided as a visual notification to a technician or a monitoring third party that the engineering process execution has been validated. For example, the monitoring system may provide data to a technician display that the engineering process execution has been validated, indicating that the project is satisfactorily completed. Additionally, in block 526, the monitoring system may certify the engineering process execution as having been completed according to the requirements of the engineering process, and may provide certification data indicating that the workpiece is ready for service. In some embodiments, certification of the engineering process execution may include storage of validation information, or the other tracking information, regarding validation of execution of the engineering process. For example, documentation of task completion or other validation information may be sent to storage system such as management system, a central repository, or like, including, but not limited to, a database, a certifying authority or certification storage, inventory system, virtual model tracking system, part or maintenance manage system, or other tracking system. The documentation of validation information may be used for verification that an engineering process was performed correctly, or for tracking of maintenance, parts, health history, or the like.

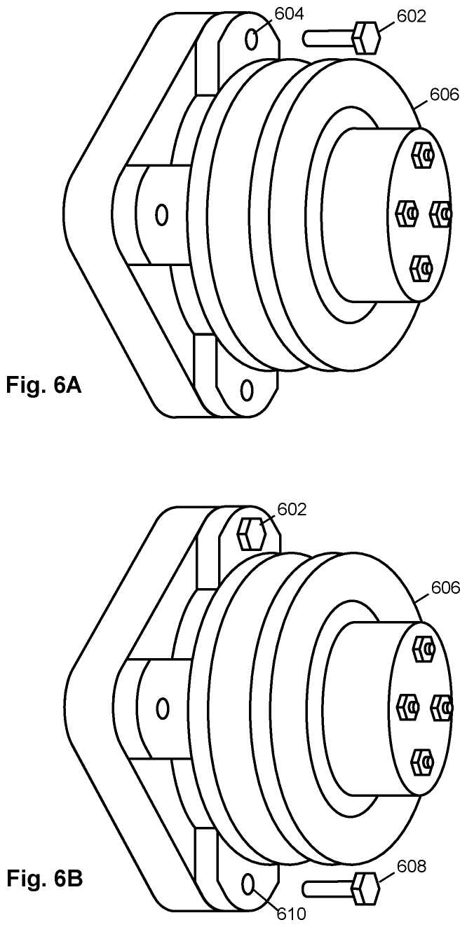

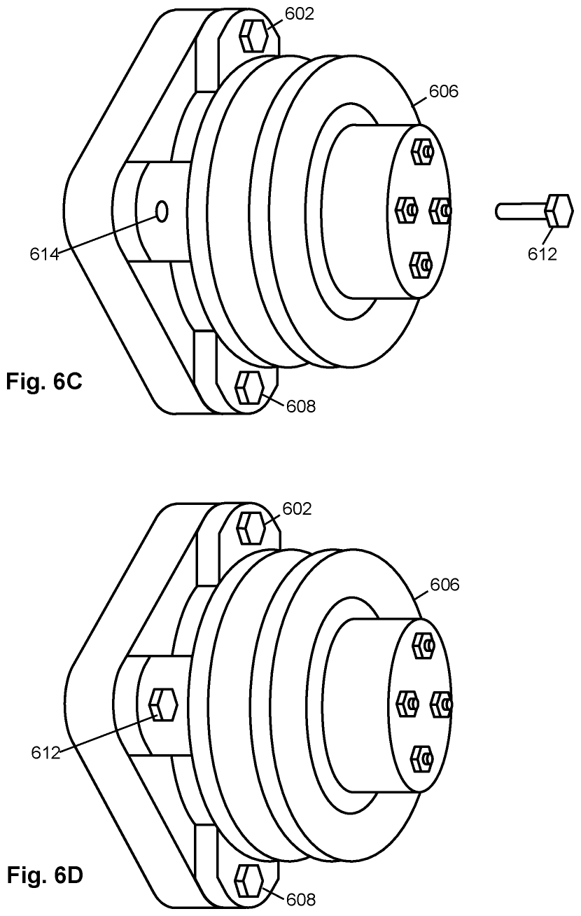

FIGS. 6A-6D are perspective diagrams illustrating an engineering process that may be monitored by an AI model according to some embodiments. FIG. 6A is a diagram illustrating an arrangement for working on a belt driven pump 606. An AI model may receive sensor data related to the pump 606, and one or more parts of interest, such as a bolt 602. The sensor data may include video data, spatial data reflecting gesture sensing, depth estimation or the like from sensors using lidar, millimeter wave radar, sonar, or the like, or may include tool reporting data, or any other type of data. The monitoring system may receive monitoring data on the arrangement, such as the location of a bolt 602, and the technician may move the bolt 602 to a relevant target location 604 associated with the pump 606. AI models of the monitoring system may be trained to recognize the pump 606 as a target structure, and the bolt 602 as a part of interest, and may monitor the technician moving the bolt 602 to the target location 604 and performing an action or gesture, such as turning the bolt 602 in the target location 604 using a particular tool. The AI models may attempt to classify the actions, gestures, and objects reflected in the monitoring data as a correct part of a relevant engineering process element.

FIGS. 6B and 6C are diagrams illustrating an arrangement 600 for additional engineering process element for the engineering process of working on a belt driven pump 606. The AI models may recognize that a first bolt 602 has been installed, and may verify, after installation, that the part of interest, in this example, the first bolt 602, is correctly installed. Additionally, the AI model may monitor installation of a second bolt 608 and a third bolt 612 in respective target locations 610, 614. The AI models may track the order the bolts were installed, and ensure that the bolts are installed correctly, and in the correct order.

FIG. 6D is a diagram illustrating an arrangement for a complete engineering process element for the engineering process of manipulating a belt driven pump 606. In some embodiments, after the technician completes actions associated with the engineering process element, the AI model may continue to monitor the work piece processing sensor data to ensure that each part, such the bolts 602, 608, 612, are correctly installed, and have not been removed or changed after being correctly installed.

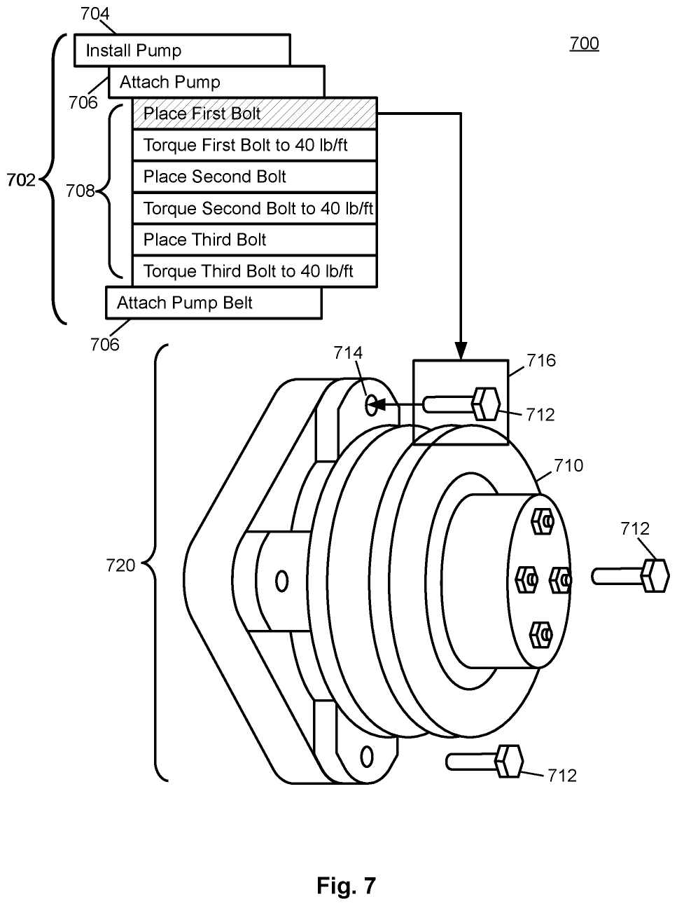

FIG. 7 is a diagram illustrating a system for providing engineering process information according to some embodiments. In some embodiments, an AR display may be used to overlay engineering process data 702 over a live view 720 of a target structure. In the disclosed embodiment, a belt driven pump 710 is shown, and as a technician installs one or more parts of interest 712 such as bolts into relevant target locations 714, the AI models may recognize completion of each engineering process element, and update or indicate a current or next engineering process element.

For example, the engineering process data 702 may be a graphically represented list of sub processes 706 and engineering process elements 708. The current engineering process element 708 may be highlighted to assist the technician in performing the engineering process correctly. Additionally, the engineering process data 702 may further include relevant data such as tools to be used, parameters used for installing or handling relevant parts, of the like. In the disclosed embodiment, a torque specification for each bolt may be determined from data indicating the engineering process, and may be displayed in the engineering process data 702 to a technician.

In some embodiments, the AR display may also provide a suggestion for a next engineering process element, part to be used, or the like. In some embodiments, an AI model may determine a next part or element from data associated with an engineering process, and may display data related to a suggested part. For example, where an AI model locates a suggested part in a visual field of the AI device based on camera data from the AR device, the AI model may instruct the AR device to provide a graphical highlight 716 indicating a next or suggested part. In other embodiments, the AI model may cause the AR display to provide text indicating a suggested part, step, action or engineering process element, or may provide a graphical representation of the suggested part, action, or the like.

An embodiment system includes at least one processor, and a non-transitory computer readable medium connected to the processor and having at least one artificial intelligence (AI) model stored therein, and further having a computer program for execution by the processor stored therein. The computer program includes instructions for determining an engineering process to be performed on a workpiece, where the engineering process has one or more engineering process elements associated with one of an assembly process or a maintenance process for the workpiece, receiving sensor data from one or more sensors associated with the workpiece, the sensor data reflecting at least a physical state of the workpiece, providing the sensor data to the at least one AI model, causing the at least one AI model to process the sensor data to generate at least one classification result, where the at least one classification result indicates whether the sensor data indicates whether each engineering process element of the one or more engineering process elements was correctly performed, validating execution of the engineering process in response to each engineering process element of the one or more engineering process elements being correctly performed, and providing a visual notification to a user that the execution of the engineering process has been validated.

In some embodiments, a first engineering process element of the one or more engineering process elements includes a step of manipulating at least a part of the workpiece. In some embodiments, the first engineering process element includes a step of at least one of a technician manipulating at least a part of the workpiece according to a specified parameter, or a technician manipulating at least a part of the workpiece using a specified tool. In some embodiments, the computer program further includes instructions for providing validation information to a storage system, where the validation information is associated with at least one of verification that the engineering process was performed correctly, tracking of maintenance, tracking of parts, or tracking of health history. In some embodiments, the computer program further includes instructions for providing engineering process data associated with the engineering process to a display, the engineering process data causing the display to display a graphic representation of a list of sub processes and engineering process elements associated with the engineering process. In some embodiments, a first AI model of the least one AI model is an object recognition model, and the instructions for causing the at least one AI model to process the sensor data include instructions for causing the first AI model to perform object recognition on the sensor data. In some embodiments, the instructions for causing the first AI model to perform object recognition include instructions for causing the first AI model to perform identifying a part of interest, and validating the part of interest. In some embodiments, the instructions for causing the first AI model to perform object recognition further include instructions for causing the first AI model to perform validating at least one of a part location, a part usage, or part placement, of the part of interest.

An embodiment method includes determining, by a monitoring system, an engineering process to be performed on a workpiece, where the engineering process has one or more engineering process elements associated with one of an assembly process or a maintenance process for the workpiece, where the monitoring system includes at least one artificial intelligence (AI) model, receiving sensor data from one or more sensors associated with the workpiece, the sensor data reflecting at least a physical state of the workpiece, providing the sensor data to the at least one AI model, causing the at least one AI model to process the sensor data to generate at least one classification result, where the at least one classification result indicates whether the sensor data indicates whether each engineering process element of the one or more engineering process elements was correctly performed, validating execution of the engineering process in response to each engineering process element of the one or more engineering process elements being correctly performed, and providing a visual notification to a user that the execution of the engineering process has been validated.

In some embodiments, a first engineering process element of the one or more engineering process elements includes a step of manipulating at least a part of the workpiece. In some embodiments, the first engineering process element includes a step of a technician manipulating at least a part of the workpiece according to a specified parameter. In some embodiments, the first engineering process element includes a step of a technician manipulating at least a part of the workpiece using a specified tool. In some embodiments, the method further includes providing engineering process data associated with the engineering process to a display, the engineering process data causing the display to display a graphic representation of a list of sub processes and engineering process elements associated with the engineering process. In some embodiments, a first AI model of the least one AI model is an object recognition model, and the method further includes causing the at least one AI model to process the sensor data to perform object recognition on the sensor data. In some embodiments, the causing the first AI model to perform object recognition includes identifying a part of interest, and validating the part of interest. In some embodiments, causing the first AI model to perform object recognition further includes validating at least one of a part location, a part usage, or part placement, of the part of interest.

An embodiment system includes at least one processing circuit, configured to implement at least one artificial intelligence (AI) model, and further configured for receiving sensor data from one or more sensors associated with a workpiece, the sensor data reflecting at least a physical state of the workpiece, providing the sensor data to the at least one AI model, causing the at least one AI model to generate, according to the sensor data, classification results for a plurality of engineering process elements for an engineering process that is associated with one of an assembly process or a maintenance process for the workpiece, where each classification result of the classification results is associated whether each engineering process element of the plurality of engineering process elements was correctly performed, validating execution of the engineering process in response to each engineering process element of the plurality of engineering process elements being correctly performed, providing a visual notification to a user that the execution of the engineering process has been validated in response to the execution of the engineering process being validated, and providing a visual notification to the user that the engineering process was incorrectly completed in response to the execution of the engineering process not being validated.

In some embodiments, the system further includes a display, where the at least one processing circuit is further configured for providing engineering process data associated with the engineering process to the display, the engineering process data causing the display to display a graphic representation of at least a portion of the plurality of engineering process elements. In some embodiments, a first AI model of the least one AI model is an object recognition model, and where the at least one processing circuit being configured for causing the at least one AI model to generate the classification results includes the at least one processing circuit being configured for causing the first AI model to perform object recognition on the sensor data. In some embodiments, the at least one processing circuit being configured for causing the first AI model to perform object recognition includes the at least one processing circuit being configured for causing the first AI model to perform identifying a part of interest, validating the part of interest, and, validating at least one of a part location, a part usage, or part placement, of the part of interest.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A system, comprising:
at least one processor; and
a non-transitory computer readable medium connected to the processor and having at least one artificial intelligence (AI) model stored therein, and further having a computer program for execution by the processor stored therein, the computer program including instructions for:
determining an engineering process to be performed on a workpiece, wherein the engineering process has one or more engineering process elements associated with one of an assembly process or a maintenance process for the workpiece;
receiving sensor data from one or more sensors associated with the workpiece, the sensor data reflecting at least a physical state of the workpiece;
providing the sensor data to the at least one AI model;
causing the at least one AI model to process the sensor data to generate at least one classification result, wherein the at least one classification result indicates whether the sensor data indicates whether each engineering process element of the one or more engineering process elements was correctly performed;
validating execution of the engineering process in response to each engineering process element of the one or more engineering process elements being correctly performed; and
providing a visual notification to a user that the execution of the engineering process has been validated.

2. The system of claim 1, wherein a first engineering process element of the one or more engineering process elements comprises a step of manipulating at least a part of the workpiece.

3. The system of claim 2, wherein the first engineering process element comprises a step of at least one of a technician manipulating at least a part of the workpiece according to a specified parameter, or a technician manipulating at least a part of the workpiece using a specified tool.

4. The system of claim 1, wherein the computer program further includes instructions for providing validation information to a storage system, wherein the validation information is associated with at least one of verification that the engineering process was performed correctly, tracking of maintenance, tracking of parts, or tracking of health history.

5. The system of claim 1, wherein the computer program further includes instructions for providing engineering process data associated with the engineering process to a display, the engineering process data causing the display to display a graphic representation of a list of sub processes and engineering process elements associated with the engineering process.

6. The system of claim 1, wherein a first AI model of the least one AI model is an object recognition model, and wherein the instructions for causing the at least one AI model to process the sensor data include instructions for causing the first AI model to perform object recognition on the sensor data.

7. The system of claim 6, wherein the instructions for causing the first AI model to perform object recognition comprise instructions for causing the first AI model to perform:
identifying a part of interest; and
validating the part of interest.

8. The system of claim 7, wherein the instructions for causing the first AI model to perform object recognition further comprise instructions for causing the first AI model to perform:
validating at least one of a part location, a part usage, or part placement, of the part of interest.

9. A method, comprising:
determining, by a monitoring system, an engineering process to be performed on a workpiece, wherein the engineering process has one or more engineering process elements associated with one of an assembly process or a maintenance process for the workpiece, wherein the monitoring system comprises at least one artificial intelligence (AI) model;
receiving sensor data from one or more sensors associated with the workpiece, the sensor data reflecting at least a physical state of the workpiece;
providing the sensor data to the at least one AI model;
causing the at least one AI model to process the sensor data to generate at least one classification result, wherein the at least one classification result indicates whether the sensor data indicates whether each engineering process element of the one or more engineering process elements was correctly performed;
validating execution of the engineering process in response to each engineering process element of the one or more engineering process elements being correctly performed; and
providing a visual notification to a user that the execution of the engineering process has been validated.

10. The method of claim 9, wherein a first engineering process element of the one or more engineering process elements comprises a step of manipulating at least a part of the workpiece.

11. The method of claim 10, wherein the first engineering process element comprises a step of a technician manipulating at least a part of the workpiece according to a specified parameter.

12. The method of claim 10, wherein the first engineering process element comprises a step of a technician manipulating at least a part of the workpiece using a specified tool.

13. The method of claim 9, further comprising providing engineering process data associated with the engineering process to a display, the engineering process data causing the display to display a graphic representation of a list of sub processes and engineering process elements associated with the engineering process.

14. The method of claim 9, wherein a first AI model of the least one AI model is an object recognition model; and
wherein the method further comprises causing the at least one AI model to process the sensor data to perform object recognition on the sensor data.

15. The method of claim 14, wherein the causing the first AI model to perform object recognition comprises:
identifying a part of interest; and
validating the part of interest.

16. The method of claim 15, wherein the causing the first AI model to perform object recognition further comprises:
validating at least one of a part location, a part usage, or part placement, of the part of interest.

17. A system, comprising:
at least one processing circuit, configured to implement at least one artificial intelligence (AI) model, and further configured for:
receiving sensor data from one or more sensors associated with a workpiece, the sensor data reflecting at least a physical state of the workpiece;
providing the sensor data to the at least one AI model;
causing the at least one AI model to generate, according to the sensor data, classification results for a plurality of engineering process elements for an engineering process that is associated with one of an assembly process or a maintenance process for the workpiece, wherein each classification result of the classification results is associated whether each engineering process element of the plurality of engineering process elements was correctly performed;
validating execution of the engineering process in response to each engineering process element of the plurality of engineering process elements being correctly performed;
providing a visual notification to a user that the execution of the engineering process has been validated in response to the execution of the engineering process being validated; and
providing a visual notification to the user that the engineering process was incorrectly completed in response to the execution of the engineering process not being validated.

18. The system of claim 17, further comprising a display;
wherein the at least one processing circuit is further configured for providing engineering process data associated with the engineering process to the display, the engineering process data causing the display to display a graphic representation of at least a portion of the plurality of engineering process elements.

19. The system of claim 17, wherein a first AI model of the least one AI model is an object recognition model, and wherein the at least one processing circuit being configured for causing the at least one AI model to generate the classification results comprises the at least one processing circuit being configured for causing the first AI model to perform object recognition on the sensor data.

20. The system of claim 19, wherein the at least one processing circuit being configured for causing the first AI model to perform object recognition comprises the at least one processing circuit being configured for causing the first AI model to perform:
identifying a part of interest;
validating the part of interest; and
validating at least one of a part location, a part usage, or part placement, of the part of interest.
